(19) United States
(12) Patent Application Publication
(10) Pub. No.: US 2019/0099693 A1
(43) Pub. Date: Apr. 4, 2019

(54) Combined Solids-Producing Direct-Contact Exchange and Separations

(71) Applicants: Larry Baxter, Orem, UT (US); Nathan Davis, Bountiful, UT (US)

(72) Inventors: Larry Baxter, Orem, UT (US); Nathan Davis, Bountiful, UT (US)

(21) Appl. No.: 15/724,657

(22) Filed: Oct. 4, 2017

(51) Int. Cl. B01D 9/00; B01D 11/04; B01J 8/00; F28B 3/04; F28B 9/04

(52) U.S. Cl. CPC B01D 9/0009; B01D 11/0492; B01J 8/007; B01J 2219/0013; F28B 9/04; B01D 2009/0086; B01J 2219/00121; F28B 3/04

(57) ABSTRACT

A method for separating a dissolved product from a liquid is disclosed. A carrier liquid is cooled in a direct-contact exchanger, the direct-contact exchanger using a liquid coolant to cool the carrier liquid. The carrier liquid comprises a dissolved product. The carrier liquid and the liquid coolant are substantially immiscible. A portion of the dissolved product is condensed, frozen, deposited, desublimated, or a combination thereof out of the carrier liquid as a solid product at a liquid-liquid interface between the liquid coolant and the carrier liquid. The solid product is entrained in the carrier liquid, the liquid coolant, or a combination thereof. The solid product is separated from the carrier liquid, the liquid coolant, or a combination thereof.

### GOVERNMENT INTEREST STATEMENT

This invention was made with government support under DE-FE0028697 awarded by the Department of Energy. The government has certain rights in the invention.

### FIELD OF THE INVENTION

The devices, systems, and methods described herein relate generally to solvent/solute separations. More particularly, the devices, systems, and methods described herein relate to separating a solute from a solvent through solid production and immiscible fluids.

### BACKGROUND

Solvent/solute separations are a critical aspect of almost every industry. Many methods involve adding significant heat, (e.g., distillation). Often, these separations require several unit operations for desired purities. A device, system, and method for accomplishing solvent/solute separations without these deficiencies would be beneficial.

### SUMMARY

A method for separating a dissolved product from a liquid is disclosed. A carrier liquid is cooled in a direct-contact exchanger, the direct-contact exchanger using a liquid coolant to cool the carrier liquid. The carrier liquid comprises a dissolved product. The carrier liquid and the liquid coolant are substantially immiscible. A portion of the dissolved product is condensed, frozen, deposited, desublimated, or a combination thereof out of the carrier liquid as a solid product at a liquid-liquid interface between the liquid coolant and the carrier liquid. The solid product is entrained in the carrier liquid, the liquid coolant, or a combination thereof. The solid product is separated from the carrier liquid, the liquid coolant, or a combination thereof.

The carrier liquid may be a slurry comprising an entrained solid product and the dissolved product may deposit on the entrained solid product at the liquid-liquid interface. At least a portion of the entrained solid product may melt as the dissolved product deposits on the entrained solid product. The entrained solid product may be a same compound as the dissolved product. The entrained solid product may be a solid form of the dissolved product.

The direct-contact exchanger may further comprise a bubble contactor, a spray tower, a distillation column, or a combination thereof. The direct-contact exchanger may further comprise a carrier liquid inlet, a liquid coolant inlet, and a liquid outlet.

The carrier liquid may enter the direct-contact exchanger through the carrier liquid inlet, the liquid coolant may enter the direct-contact exchanger through the liquid coolant inlet, and the carrier liquid, the liquid coolant, and the solid product may exit the direct-contact exchanger through the liquid outlet.

Separating the solid product may comprise passing the carrier liquid, the liquid coolant, and the solid product through a liquid-liquid separator to produce a substantially pure carrier liquid and a slurry of the liquid coolant and the solid product or a substantially pure liquid coolant and a slurry of the carrier liquid and the solid product, and passing the slurry through a solid-liquid separator separating out the solid product.

Separating the solid product may comprise passing the carrier liquid, the liquid coolant, and the solid product through a liquid-liquid separator to produce the carrier liquid and a slurry of the liquid coolant and the solid product with a portion of the carrier liquid entrained or the liquid coolant and a slurry of the carrier liquid and the solid product with a portion of the liquid coolant entrained, and passing the slurry through a solid-liquid separator separating out the solid product.

The direct-contact exchanger may further comprise a mixing section and a stilling section. The carrier liquid cooling may comprise mixing the liquid coolant and the carrier liquid in the mixing section. The carrier liquid and liquid coolant may be passed from the mixing section into the stilling section and the carrier liquid and liquid coolant may be separated into layers. The layers may be decanted through separate outlets. The carrier liquid may be passed through a solid-liquid separator to separate the solid product from the carrier liquid. The liquid coolant may be passed through a solid-liquid separator to separate the solid product from the liquid coolant.

The liquid coolant and the carrier liquid may comprise a polar compound and a non-polar compound; a non-polar compound and a polar compound; a first material and a second material, wherein the first material has a strong affinity for itself and a weak affinity for the second material; a first material and a second material, wherein the second material has a strong affinity for itself and a weak affinity for the first material; a first material of a first pure-component density and a second material of a second pure-component density, wherein the first pure-component density and the second pure-component density are substantially different; or a combination thereof.

The dissolved product may comprise carbon dioxide, nitrogen oxide, sulfur dioxide, nitrogen dioxide, sulfur trioxide, hydrogen sulfide, hydrogen cyanide, water, hydrocarbons, or combinations thereof.

The liquid coolant may comprise a mixture comprising a solvent and a compound from a group consisting of ionic compounds and soluble organic compounds. The ionic compounds may comprise potassium carbonate, potassium formate, potassium acetate, calcium magnesium acetate, magnesium chloride, sodium chloride, lithium chloride, and calcium chloride. The soluble organic compounds may comprise glycerol, ammonia, propylene glycol, ethylene glycol, ethanol, and methanol. The solvent may comprise water, hydrocarbons, liquid ammonia, liquid carbon dioxide, cryogenic liquids, or combinations thereof.

The solid product may be non-wettable by the carrier liquid or the liquid coolant, the solid product forming a layer between, above, or below the carrier liquid and the liquid coolant.

### BRIEF DESCRIPTION OF THE DRAWINGS

In order that the advantages of the described devices, systems, and methods will be readily understood, a more particular description of the devices, systems, and methods, briefly described above, will be rendered by reference to specific embodiments illustrated in the appended drawings. Understanding that these drawings depict only typical embodiments of the invention and are not therefore to be considered limiting of its scope, the invention will be described and explained with additional specificity and detail through use of the accompanying drawings, in which:

FIG. 1A shows a side isometric cutaway view of a combined direct-contact exchanger and solid-liquid separator.

FIG. 1B shows a cross-sectional side view of the combined exchanger and separator of FIG. 1A.

FIG. 2 shows a cross-sectional side view of a direct-contact exchanger.

FIG. 3 shows a cross-sectional side view of a direct-contact exchanger.

FIG. 4 shows a method for separating a dissolved product from a liquid.

FIG. 5 shows a method for separating a dissolved product from a liquid.

### DETAILED DESCRIPTION

It will be readily understood that the components of the present devices, systems, and methods, as generally described and illustrated in the Figures herein, could be arranged and designed in a wide variety of different configurations. Thus, the following more detailed description of the embodiments of the invention, as represented in the Figures, is not intended to limit the scope of the invention, as claimed, but is merely representative of certain examples of presently contemplated embodiments in accordance with the described devices, systems, and methods.

Separating a solute from a solvent, or in other words, separating a dissolved product from a carrier liquid, is accomplished by the devices, systems, and methods disclosed herein. Rather than distillation, as is typical for these types of separations, the carrier liquid is cooled against a coolant that is immiscible with the carrier liquid. This immiscibility means that the liquids do not significantly solvate into one another. As such, heat and material exchange occurs at the liquid-liquid interface. The coolant temperature is chosen such that the dissolved product condenses, freezes, deposits, or desublimates out of the carrier liquid as a solid product. This solid product entrains in either the carrier liquid or the coolant and can then be separated from the liquids. As a result, the dissolved product is removed from the carrier liquid without distillation, heating, or substantial mixing of liquids.

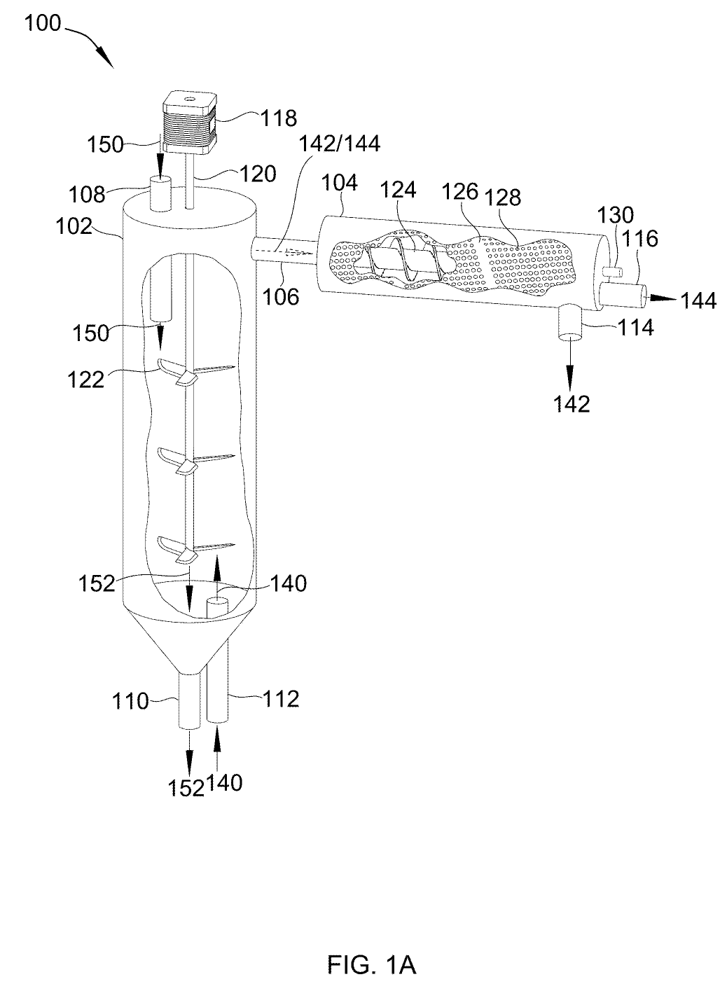

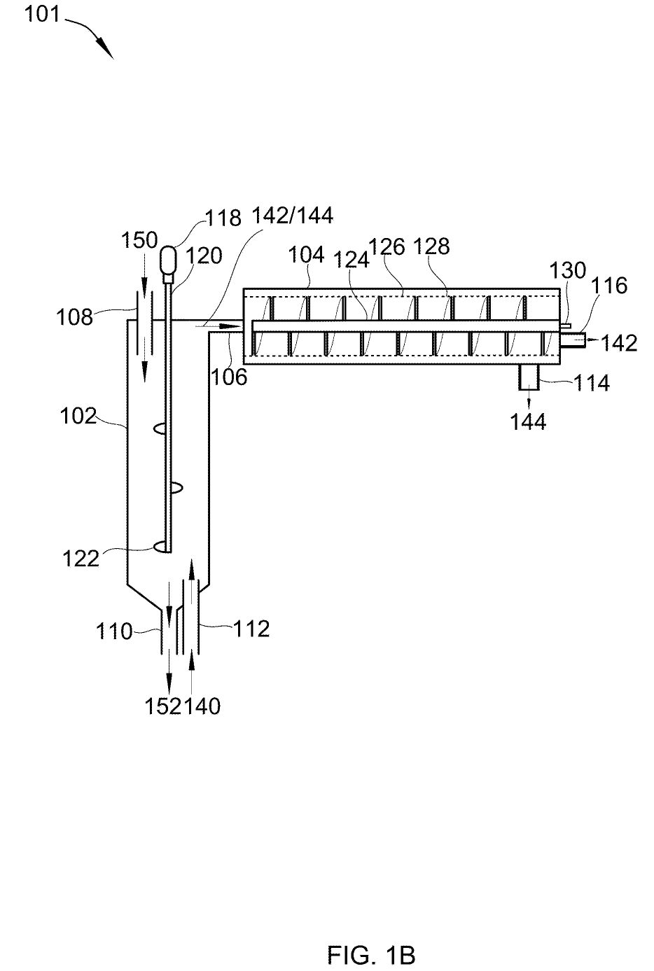

Referring now to the Figures, FIG. 1A shows a side isometric cutaway view 100 of a combined direct-contact exchanger 102 and solid-liquid separator 104 that may be used in the described devices, systems, and methods. FIG. 1B shows a cross-sectional side view 101 of the combined exchanger 102 and separator 104 of FIG. 1A. Direct-contact exchanger 102 is a liquid-liquid exchanger comprising top inlet 108, bottom inlet 112, bottom outlet 110, transfer pipe 106 (as a top outlet), mixer motor 118, mixer shaft 120, and mixer blades 122. Solid-liquid separator 104 is a filtering screw auger comprising transfer pipe 106 (as a feed inlet), screw auger 124, filter plate 126, filter plate holes 128, auger drive shaft 130, liquid outlet 114, and solids outlet 116.

Liquid coolant 150 enters direct-contact exchanger 102 through top inlet 108 as carrier liquid 140 enters through bottom inlet 112. Carrier liquid 140 includes a dissolved product and is substantially immiscible with liquid coolant 150. Carrier liquid 140 and liquid coolant 150 are mixed by mixer blades 122, liquid coolant 150 cooling carrier liquid 140 such that at least a portion of the dissolved product condenses, freezes, deposits, desublimates, or a combination thereof out of carrier liquid 140 as solid product 144 at an interface between liquid coolant 140 and carrier liquid 140. In some embodiments, carrier liquid 140 is less dense than liquid coolant 150. Liquid coolant 150 becomes warm liquid coolant 152 and leaves through bottom outlet 110. Solid product 144 becomes entrained in now depleted carrier liquid 142 and the combined stream 142/144 passes through transfer pipe 106 into solid-liquid separator 104. Combined stream 142/144 is pressurized by screw auger 124 as it passes through solid-liquid separator 106, causing depleted carrier liquid 142 to be pressed through filter plate 126 and out liquid outlet 114. Solid product 144, now substantially pure, passes out solids outlet 116.

In some embodiments, solid product 144 entrains in warm liquid coolant 152 and a solid-liquid separator 104 (not shown) may be located off of bottom outlet 110 rather than transfer pipe 106. In some embodiments, solid product 144 entrains in both warm liquid coolant 152 and depleted carrier liquid 142, and solid-liquid separators 104 may be installed in both locations.

In some embodiments, liquid coolant 150 is less dense than carrier liquid 140 and the inlets for carrier liquid 140 and liquid coolant 140 are switched. In this case, solid-liquid separator 106 can again be located at the top, the bottom, or both, depending on which stream entrains solid product 144.

In a first exemplary instance, carrier liquid 140 comprises pentane. The dissolved product in the pentane comprises carbon dioxide. In this instance, carrier liquid 140 also has already entrained solids, also comprising carbon dioxide. Liquid coolant 150 comprises a eutectic mixture of water and lithium chloride. Solid-liquid separator 106 is attached to bottom outlet 110. Carbon dioxide condenses, desublimates, and freezes out of the pentane as well as deposits onto already entrained solids, resulting in solid product 144 comprising carbon dioxide and dry pentane. Solid product 144 entrains in liquid coolant 150. The dry pentane passes out liquid outlet 114.

In a second exemplary instance, carrier liquid 140 comprises liquified natural gas. The dissolved product in the liquified natural gas comprises water. Liquid coolant 150 comprises a eutectic mixture of water and potassium acetate. Solid-liquid separator 106 is attached to bottom outlet 110. Water condenses and freezes out of the liquified natural gas, resulting in solid product 144 comprising water and a dry liquified natural gas. Solid product 144 entrains in liquid coolant 150. The dry liquified natural gas passes out liquid outlet 114.

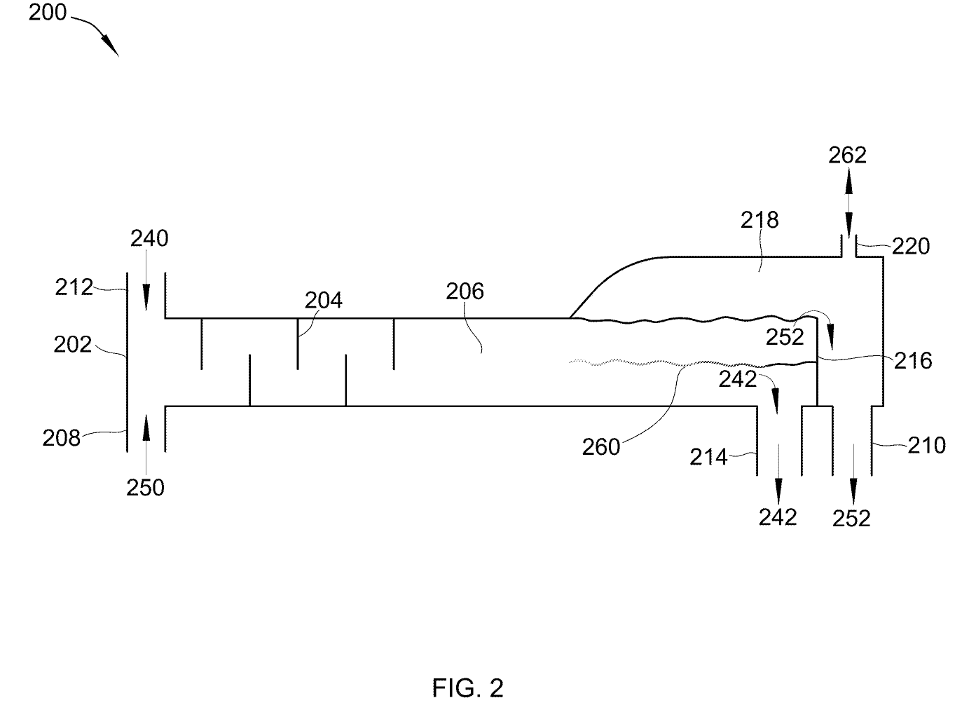

FIG. 2 shows a cross-sectional side view 200 of a direct-contact exchanger 202 that may be used in the described devices, systems, and methods. Direct-contact exchanger 202, a liquid-liquid exchanger, comprises first liquid inlet 212, second liquid inlet 208, baffles 204, stilling section 206, weir 216, bottom liquid outlet 214, top liquid outlet 210, vapor space 218, and pressure equalization port 220. Carrier liquid 240 (e.g., carrier liquid 140) enters first liquid inlet 212 as liquid coolant 250 (e.g., liquid coolant 150) enters second liquid inlet 208. Carrier liquid 240 comprises a dissolved product. Carrier liquid 240 is cooled by liquid coolant 250 as they mix while passing around baffles 204. Carrier liquid 240 is denser than liquid coolant 250 and the liquids are substantially immiscible in each other. A portion of the dissolved product condenses, freezes, deposits, desublimates, or a combination thereof out of carrier liquid 240 as a solid product at liquid-liquid interface 260. Carrier liquid 240 becomes depleted carrier liquid 242 and liquid coolant 250 becomes warm liquid coolant 252. The solid product entrains in either depleted carrier liquid 242, warm liquid coolant 252, or a combination thereof. Depleted carrier liquid 242 and warm liquid coolant 252 separate into layers in stilling section 206. Warm liquid coolant 252 spills over weir 216 and passes out of top liquid outlet 210. Depleted carrier liquid 242 passes out of bottom liquid outlet 214. Vapor space 218 allows for pressure variations, with pressure equalization through pressure equalization port 220. The solid product is separated from depleted carrier liquid 242, warm liquid coolant 252, or a combination thereof, by one or more solid-liquid separators.

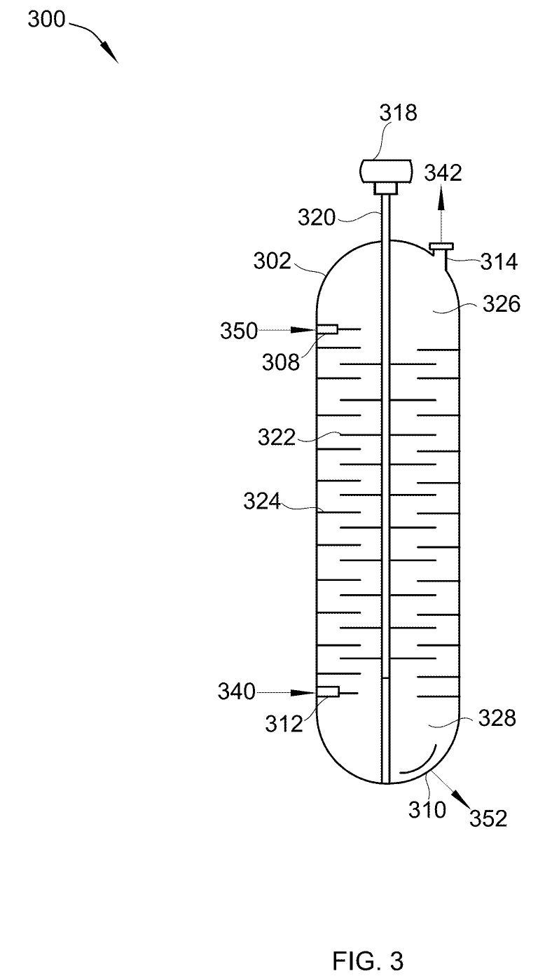

FIG. 3 shows a cross-sectional side view 300 of a direct-contact exchanger 302 that may be used in the described devices, systems, and methods. Direct-contact exchanger 302, a liquid-liquid exchanger, comprises first liquid inlet 312, second liquid inlet 308, baffles 324, mixer motor 318, mixing shaft 320, mixing blades 322, top liquid outlet 314, and bottom liquid outlet 310. Carrier liquid 340 (e.g., carrier liquid 140, 240) enters first liquid inlet 312 as liquid coolant 350 (e.g., liquid coolant 150, 250) enters second liquid inlet 308. Carrier liquid 340 comprises a dissolved product. Carrier liquid 340 is denser than liquid coolant 350 and the liquids are substantially immiscible in each other. Carrier liquid 340 is cooled by liquid coolant 350 as they are mixed by mixing blades 322 and baffles 324. A portion of the dissolved product condenses, freezes, deposits, desublimates, or a combination thereof out of carrier liquid 340 as a solid product at the liquid-liquid interface between the immiscible liquids 340 and 350. Carrier liquid 340 becomes depleted carrier liquid 342 and liquid coolant 350 becomes warm liquid coolant 352. The solid product entrains in either depleted carrier liquid 342, warm liquid coolant 352, or a combination thereof. Depleted carrier liquid 342 and warm liquid coolant 352 separate in spaces 326 above and 328 below mixing blades 322. Warm liquid coolant 352 passes out of top liquid outlet 314. Depleted carrier liquid 342 passes out of bottom liquid outlet 310. The solid product is separated from depleted carrier liquid 342, warm liquid coolant 352, or a combination thereof, by one or more solid-liquid separators.

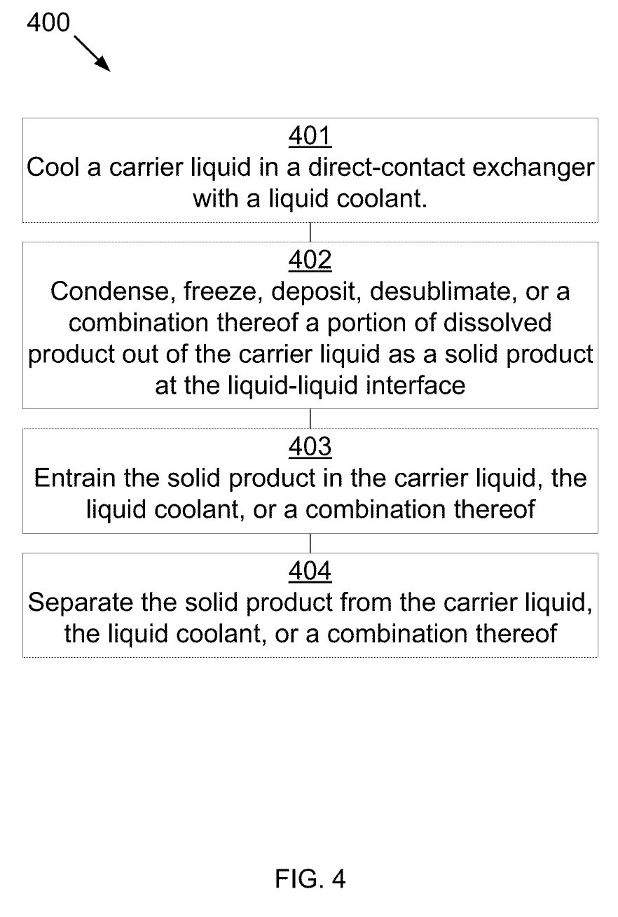

FIG. 4 shows a method 400 for separating a dissolved product from a liquid that may be used in the described devices, systems, and methods. A carrier liquid is cooled in a direct-contact exchanger, the direct-contact exchanger using a liquid coolant to cool the carrier liquid 401. The carrier liquid comprises a dissolved product. The carrier liquid and the liquid coolant are substantially immiscible. A portion of the dissolved product is condensed, frozen, deposited, desublimated, or a combination thereof out of the carrier liquid as a solid product at a liquid-liquid interface between the liquid coolant and the carrier liquid 402. The solid product is entrained in the carrier liquid, the liquid coolant, or a combination thereof 403. The solid product is separated from the carrier liquid, the liquid coolant, or a combination thereof 404.

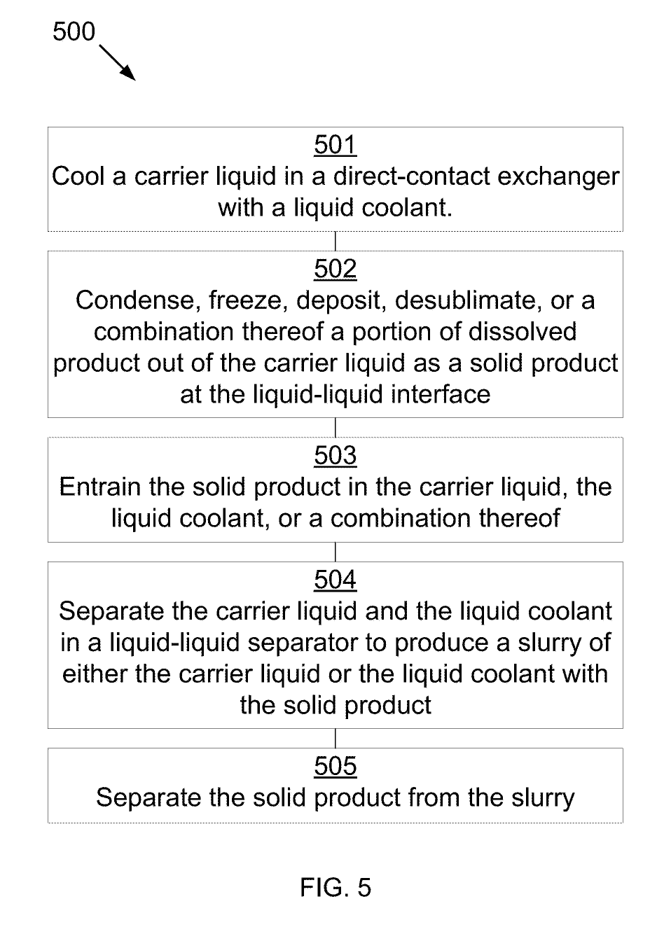

FIG. 5 shows a method 500 for separating a dissolved product from a liquid that may be used in the described devices, systems, and methods. A carrier liquid is cooled in a direct-contact exchanger, the direct-contact exchanger using a liquid coolant to cool the carrier liquid 501. The carrier liquid comprises a dissolved product. The carrier liquid and the liquid coolant are substantially immiscible. A portion of the dissolved product is condensed, frozen, deposited, desublimated, or a combination thereof out of the carrier liquid as a solid product at a liquid-liquid interface between the liquid coolant and the carrier liquid 502. The solid product is entrained in the carrier liquid, the liquid coolant, or a combination thereof 503. The carrier liquid and the liquid coolant are separated through a liquid-liquid separator 504. This produces either a substantially pure carrier liquid and a slurry of the liquid coolant and the solid product or a substantially pure liquid coolant and a slurry of the carrier liquid and the solid product. The solid product is separated through a solid-liquid separator 505.

In some embodiments, the carrier liquid is a slurry comprising an entrained solid product and the dissolved product deposits on the entrained solid product at the liquid-liquid interface. In some embodiments, at least a portion of the entrained solid product melts as the dissolved product deposits on the entrained solid product. In some embodiments, the entrained solid product is the same compound as the dissolved product, and wherein the entrained solid product is a solid form of the dissolved product.

In some embodiments, the direct-contact exchanger further comprises a bubble contactor, a spray tower, a distillation column, or a combination thereof. In some embodiments, the direct-contact exchanger further comprises a carrier liquid inlet, a liquid coolant inlet, and a liquid outlet. In some embodiments, the carrier liquid enters the direct-contact exchanger through the carrier liquid inlet, the liquid coolant enters the direct-contact exchanger through the liquid coolant inlet, and the carrier liquid, the liquid coolant, and the solid product exit the direct-contact exchanger through the liquid outlet.

In some embodiments, the direct-contact exchanger further comprises a mixing section and a stilling section. In some embodiments, cooling the carrier liquid comprises mixing the liquid coolant and the carrier liquid in the mixing section. In some embodiments, separating further comprises passing the carrier liquid and liquid coolant from the mixing section into the stilling section and separating the carrier liquid and liquid coolant separate into layers. In some embodiments, separation further comprises decanting the layers through separate outlets. In some embodiments, separation further comprises passing the carrier liquid, the liquid coolant, or a combination thereof through one or more solid-liquid separators to separate out the solid product.

The method of claim 1, wherein the liquid coolant and the carrier liquid comprise, respectively, a polar compound and a non-polar compound; a non-polar compound and a polar compound; a first material and a second material, wherein the first material has a strong affinity for itself and a weak affinity for the second material; a first material and a second material, wherein the second material has a strong affinity for itself and a weak affinity for the first material; a first material of a first pure-component density and a second material of a second pure-component density, wherein the first pure-component density and the second pure-component density are substantially different; or a combination thereof.

In some embodiments, the dissolved product comprises carbon dioxide, nitrogen oxide, sulfur dioxide, nitrogen dioxide, sulfur trioxide, hydrogen sulfide, hydrogen cyanide, water, hydrocarbons, or combinations thereof.

In some embodiments, the liquid coolant comprises a mixture comprising a solvent and a compound from a group consisting of ionic compounds and soluble organic compounds. The ionic compounds comprise potassium carbonate, potassium formate, potassium acetate, calcium magnesium acetate, magnesium chloride, sodium chloride, lithium chloride, and calcium chloride. The soluble organic compounds comprise glycerol, ammonia, propylene glycol, ethylene glycol, ethanol, and methanol. The solvent comprises water, hydrocarbons, liquid ammonia, liquid carbon dioxide, cryogenic liquids, or combinations thereof.

In some embodiments, the solid product comprises a density intermediate to densities of the carrier liquid and the liquid coolant. In some embodiments, the solid product is not wettable by the carrier liquid or the liquid coolant, the solid product forming a layer between, above, or below the carrier liquid and the liquid coolant.

We claim:

1. A method for separating a dissolved product from a liquid comprising:
cooling a carrier liquid in a direct-contact exchanger, the direct-contact exchanger using a liquid coolant to cool the carrier liquid, wherein the carrier liquid comprises a dissolved product, and wherein the carrier liquid and the liquid coolant are substantially immiscible;
condensing, freezing, depositing, desublimating, or a combination thereof, a portion of the dissolved product out of the carrier liquid as a solid product at a liquid-liquid interface between the liquid coolant and the carrier liquid;
entraining the solid product in the carrier liquid, the liquid coolant, or a combination thereof;
separating the solid product from the carrier liquid, the liquid coolant, or a combination thereof.

2. The method of claim 1, wherein the carrier liquid is a slurry comprising an entrained solid product and the dissolved product deposits on the entrained solid product at the liquid-liquid interface.

3. The method of claim 2, wherein at least a portion of the entrained solid product melts as the dissolved product deposits on the entrained solid product.

4. The method of claim 2, wherein the entrained solid product is a same compound as the dissolved product, and wherein the entrained solid product is a solid form of the dissolved product.

5. The method of claim 1, wherein the direct-contact exchanger further comprises a bubble contactor, a spray tower, a distillation column, or a combination thereof.

6. The method of claim 5, wherein the direct-contact exchanger further comprises a carrier liquid inlet, a liquid coolant inlet, and a liquid outlet.

7. The method of claim 6, wherein the carrier liquid enters the direct-contact exchanger through the carrier liquid inlet, the liquid coolant enters the direct-contact exchanger through the liquid coolant inlet, and the carrier liquid, the liquid coolant, and the solid product exit the direct-contact exchanger through the liquid outlet.

8. The method of claim 7, wherein separating the solid product comprises:
passing the carrier liquid, the liquid coolant, and the solid product through a liquid-liquid separator to produce:
a substantially pure carrier liquid and a slurry of the liquid coolant and the solid product; or,
a substantially pure liquid coolant and a slurry of the carrier liquid and the solid product; and,
passing the slurry through a solid-liquid separator separating out the solid product.

9. The method of claim 7, wherein separating the solid product comprises:
passing the carrier liquid, the liquid coolant, and the solid product through a liquid-liquid separator to produce:
the carrier liquid and a slurry of the liquid coolant and the solid product with a portion of the carrier liquid entrained; or,
the liquid coolant and a slurry of the carrier liquid and the solid product with a portion of the liquid coolant entrained; and,
passing the slurry through a solid-liquid separator separating out the solid product.

10. The method of claim 5, wherein the direct-contact exchanger further comprises a mixing section and a stilling section.

11. The method of claim 10, wherein cooling the carrier liquid comprises mixing the liquid coolant and the carrier liquid in the mixing section.

12. The method of claim 11, further comprising:
passing the carrier liquid and liquid coolant from the mixing section into the stilling section; and,
separating the carrier liquid and liquid coolant separate into layers.

13. The method of claim 12, further comprising decanting the layers through separate outlets.

14. The method of claim 13, further comprising passing the carrier liquid, the liquid coolant, or a combination thereof through one or more solid-liquid separators to separate out the solid product.

15. The method of claim 1, wherein the liquid coolant and the carrier liquid comprise, respectively:
a polar compound and a non-polar compound;
a non-polar compound and a polar compound;
a first material and a second material, wherein the first material has a strong affinity for itself and a weak affinity for the second material;
a first material and a second material, wherein the second material has a strong affinity for itself and a weak affinity for the first material;
a first material of a first pure-component density and a second material of a second pure-component density, wherein the first pure-component density and the second pure-component density are substantially different; or,
a combination thereof.

16. The method of claim 1, wherein the dissolved product comprises carbon dioxide, nitrogen oxide, sulfur dioxide, nitrogen dioxide, sulfur trioxide, hydrogen sulfide, hydrogen cyanide, water, hydrocarbons, or combinations thereof.

17. The method of claim 1, wherein the liquid coolant comprises a mixture comprising a solvent and a compound from a group consisting of:
ionic compounds comprising potassium carbonate, potassium formate, potassium acetate, calcium magnesium acetate, magnesium chloride, sodium chloride, lithium chloride, and calcium chloride; and,
soluble organic compounds comprising glycerol, ammonia, propylene glycol, ethylene glycol, ethanol, and methanol.

18. The method of claim 17, wherein the solvent comprises water, hydrocarbons, liquid ammonia, liquid carbon dioxide, cryogenic liquids, or combinations thereof.

19. The method of claim 18, wherein the solid product comprises a density intermediate to densities of the carrier liquid and the liquid coolant.

20. The method of claim 1, wherein the solid product is not wettable by the carrier liquid or the liquid coolant, the solid product forming a layer between, above, or below the carrier liquid and the liquid coolant.
